(19) United States
(12) Patent Application Publication
(10) Pub. No.: US 2007/0118748 A1
(43) Pub. Date: May 24, 2007

(54) Arbitrary MAC address usage in a WLAN system

(75) Inventor: Jonathan P. Edney, Cambridgeshire (GB)

Correspondence Address: WARE FRESSOLA VAN DER SLUYS &;ADOLPHSON, LLP, BRADFORD GREEN, BUILDING 5, 755 MAIN STREET, P O BOX 224, MONROE, CT, 06468, US

(73) Assignee: Nokia Corporation

(21) Appl. No.: 11/515,413

(22) Filed: Sep. 1, 2006

Related U.S. Application Data
(60) Provisional application No. 60/714,029, filed on Sep. 2, 2005.

(51) Int. Cl. H04L 9/00

(52) U.S. Cl. 713/171

(57) ABSTRACT

The present invention provides a new and unique method and apparatus for coupling an access point (AP) or other suitable network node or terminal to a station (STA) or other suitable network node or terminal in a wireless LAN network. The present invention features the AP and the STA agreeing on an arbitrary Medium Access Address (MAC) or other suitable arbitrary address, associated with a secret value, where the arbitrary MAC is for use by the STA and AP during the connection. The arbitrary MAC address, called an “Association MAC Identifier” (AMID), may be used by the STA and AP to form a mutual connection and in all subsequent communications for the connection. The STA may also discard the AMID and acquire a new one to establish a new connection at any time or may operate with multiple AMIDs at the same time. Once an AMID is assigned to a STA, the AP prevents another STA from acquiring the same AMID value until the original STA has relinquished it or its validity has expired.

### CROSS-REFERENCE TO RELATED APPLICATIONS

This application claims benefit to provisional patent application Ser. No. 60/714,029, filed 2 Sep. 2005, which is hereby incorporated by reference in its entirety.

### BACKGROUND OF THE INVENTION

1. Field of Invention

The present invention related to a method and apparatus for connecting an access point (AP) or other suitable network node to a station (STA) or other suitable network node in a wireless LAN network.

2. Description of Related Art

FIG. 1 shows, by way of example, typical parts of an IEEE 802.11 WLAN system, which is known in the art and provides for communications between communications equipment such as mobile and secondary devices including personal digital assistants (PDAs), laptops and printers, etc. The WLAN system may be connected to a wire LAN system that allows wireless devices to access information and files on a file server or other suitable device or connecting to the Internet. The devices can communicate directly with each other in the absence of a base station in a so-called “ad-hoc” network, or they can communicate through a base station, called an access point (AP) in IEEE 802.11 terminology, with distributed services through the AP using local distributed services (DS) or wide area extended services, as shown. In a WLAN system, end user access devices are known as stations (STAs), which are transceivers (transmitters/receivers) that convert radio signals into digital signals that can be routed to and from communications device and connect the communications equipment to access points (APs) that receive and distribute data packets to other devices and/or networks. The STAs may take various forms ranging from wireless network interface card (NIC) adapters coupled to devices to integrated radio modules that are part of the devices, as well as an external adapter (USB), a PCMCIA card or a USB Dongle (self contained), which are all known in the art.

FIGS. 2a and 2b show diagrams of the Universal Mobile Telecommunications System (UMTS) packet network architecture, which is also known in the art. In FIG. 2a, the UMTS packet network architecture includes the major architectural elements of user equipment (UE), UMTS Terrestrial Radio Access Network (UTRAN), and core network (CN). The UE is interfaced to the UTRAN over a radio (Uu) interface, while the UTRAN interfaces to the core network (CN) over a (wired) Iu interface. FIG. 2b shows some further details of the architecture, particularly the UTRAN, which includes multiple Radio Network Subsystems (RNSs), each of which contains at least one Radio Network Controller (RNC). In operation, each RNC may be connected to multiple Node Bs which are the UMTS counterparts to GSM base stations. Each Node B may be in radio contact with multiple UEs via the radio interface (Uu) shown in FIG. 2a. A given UE may be in radio contact with multiple Node Bs even if one or more of the Node Bs are connected to different RNCs. For instance, a UE1 in FIG. 2b may be in radio contact with Node B2 of RNS1 and Node B3 of RNS2 where Node B2 and Node B3 are neighboring Node Bs. The RNCs of different RNSs may be connected by an Iur interface which allows mobile UEs to stay in contact with both RNCs while traversing from a cell belonging to a Node B of one RNC to a cell belonging to a Node B of another RNC. The convergence of the IEEE 802.11 WLAN system in FIG. 1 and the (UMTS) packet network architecture in FIGS. 2a and 2b has resulted in STAs taking the form of UEs, such as mobile phones or mobile terminals. The interworking of the WLAN (IEEE 802.11) shown in FIG. 1 with such other technologies (e.g. 3GPP, 3GPP2 or 802.16) such as that shown in FIGS. 2a and 2b is being defined at present in protocol specifications for 3GPP and 3GPP2. The reader is referred to WO 03/061203, entitled “Addressing in Wireless Local Area Networks”, which is hereby incorporated by reference in its entirety.

The present invention relates to such wireless LAN networks especially those according to the IEEE 802.11 standards described above. In such networks, a master slave relationship typically exists between a group of devices (usually mobile devices) called the STAs and a single coordinating device (usually fixed devices) called the AP. Messages are exchanged between each STA and the AP using a shared wireless medium. In order to ensure delivery to the correct device, each message is prefixed with address fields to identify the sender and receiver of each message. In IEEE 802.11, these are called MAC addresses. Each device is assigned globally unique MAC address during manufacture which remains with the device during its lifetime and is not reused after the device is scrapped.

In such wireless LAN networks, the MAC address fields attached to the messages can be read by any other compatible wireless device and system users cannot easily prevent unwanted stations from discovering the address information being used in the network.

The use of fixed and globally assigned MAC addresses present the following problems:

1) Since the addresses can be read by unwanted third party STAs the identity of STAs operating in the network might be discovered by unauthorized parties. There is no solution in current IEEE 802.11 networks to address this problem.

2) Since the addresses are fixed, the STA is always identified by the AP using the fixed address and it is not possible for the STA to form a new connection the AP unless the old connection can be disconnected. Under some circumstances, the STA might not be able to use or disconnect an existing connection and it thus prevented from communicating. This problem does not exist in current IEEE 802.11 systems but will occur as a result of certain changes being introduced under amendment ‘r’ thereof.

3) The STA is unable to make more than one simultaneous connection to the AP because it has only one MAC address. The only current solution in IEEE 802.11 networks to address this problem is to use multiple network interfaces.

Problems of this type have been solved for devices in other wireless networks such as cellular phone systems.

In the aforementioned WO 03/061203, it is known that temporary MAC addresses can be generated and their validity is checked by monitoring traffic or sending challenges. The temporary MAC may include, for example, a random number generated by means of a random number generator, organization-specific unique identifiers (OSI), a network identifier such as a BSS identifier BSSID.

### SUMMARY OF THE INVENTION

In its broadest sense, the present invention provides a new and unique method and apparatus for coupling an access point (AP) or other suitable network node or terminal and a station (STA) or other suitable network node or terminal in a wireless LAN network. The present invention features the AP and the STA agreeing on an arbitrary Medium Access Address (MAC) or other suitable arbitrary address, associated with a secret value, where the arbitrary MAC is for use by the STA and the AP during a connection.

The arbitrary MAC address, called an “Association MAC Identifier” (AMID), may be used by the STA to form the connection with the AP and in all subsequent communications for the connection. The AP uses the AMID for example to transmit data to the STA and therefore identify the STA. The STA may also discard the AMID and acquire a new one to establish a new connection at any time or may operate with multiple AMIDs at the same time. Once an AMID is assigned to a STA, the AP prevents another STA from acquiring the same AMID value until the original STA has relinquished it or its validity has expired.

Alternatively, a new AMID may be selected periodically to improve security. This operation for improved security may be triggered by detection of rogue WLAN devices. Detection can be done e.g. by examining the data transmissions in the network and by determining based on the traffic pattern and combination of IP and lower level addresses such as MAC addresses that there are e.g. two WLAN terminals using the same MAC address. The traffic pattern based rogue terminal detection can be based on examining what kind of management frames are sent from a certain MAC address/IP address. The WLAN terminal may also be set to a secure mode, which uses enhanced security such as the periodic renewal of the AMID.

The whole thrust of the present invention is to provide for MAC address generation in a mobile terminal using a “secret” value, as well as the method to disconnect the mobile terminal.

In addition to the MAC address generation, the present invention also includes validity checking after which the MAC address can be used. In operation, a disconnecting procedure taking place in the AP may be initiated by a message sent by the mobile terminal.

The apparatus may take the form of a wireless LAN network, as well as a network node or a network element such as an AP or STA having corresponding modules configured for performing the functionality described herein.

One advantage of the present invention is that it disables MAC tracking and rogue disconnects described above.

### BRIEF DESCRIPTION OF THE DRAWING

The drawing includes the following Figures, which are not necessarily drawn to scale:

FIG. 1 shows typical parts of an IEEE 802.11 WLAN system, which is known in the art.

FIGS. 2a and 2b show diagrams of the Universal Mobile Telecommunications System (UMTS) packet network architecture, which is also known in the art.

FIG. 3 shows an access point (AP) according to the present invention.

FIG. 4 shows a station (STA) according to the present invention.

### BEST MODE OF THE INVENTION

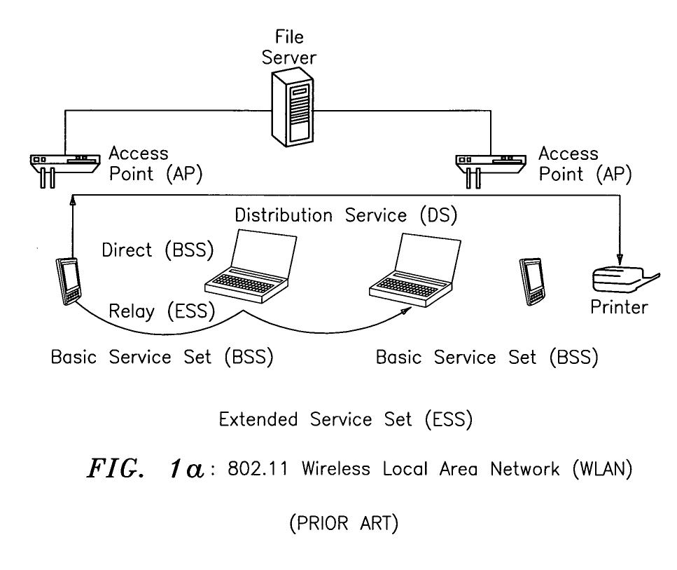

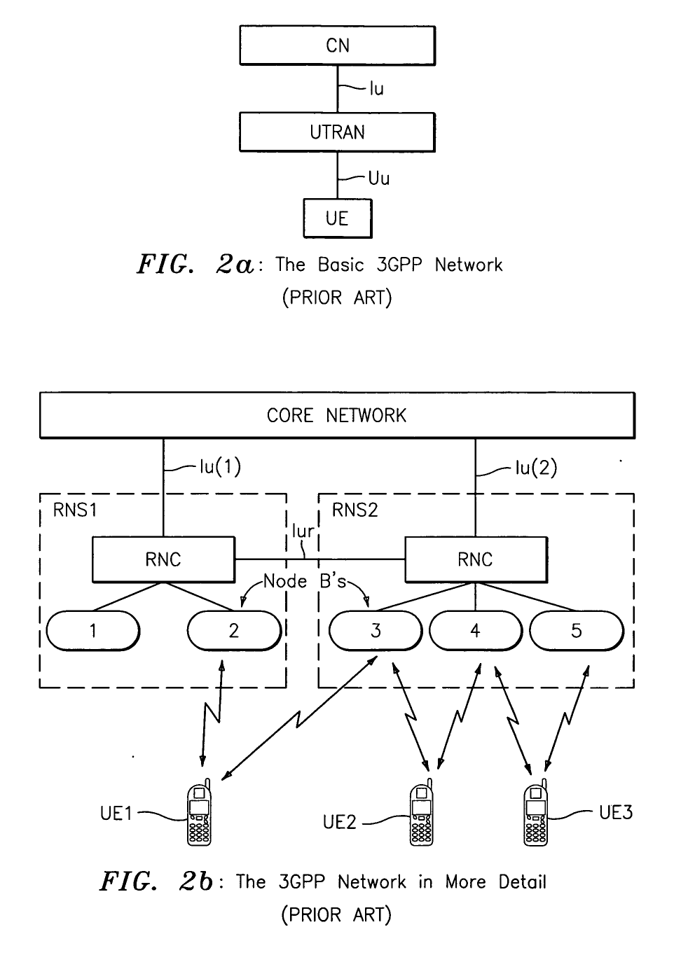

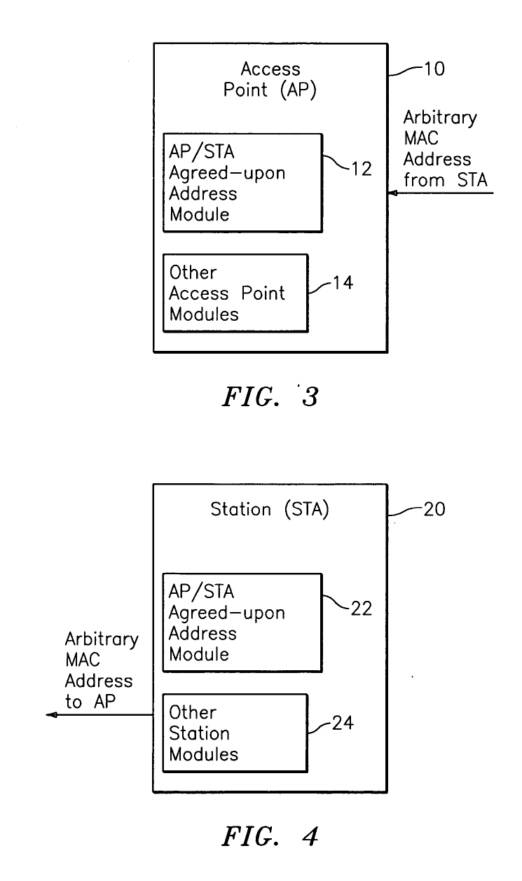

The present invention provides a new and unique method and apparatus for coupling an access point (AP) or other suitable network node or terminal 10 shown in FIG. 3 to a station (STA) or other suitable network node or terminal 20 shown in FIG. 4 in a wireless LAN network, consistent with that shown in FIG. 1. In operation, the AP 10 and the STA 20 agree on an arbitrary Medium Access Address (MAC) called association MAC identifier (AMID) or other suitable arbitrary address for use by the STA 20 during a connection. As shown, the AP 10 includes an AP/STA agreed-upon address module 12 and other access point modules 14, while the STA 20 includes a corresponding AP/STA agreed-upon address module 22 and other station modules 24.

### The Basic Implementation

The basic implementation and cooperation of the AP 10 and STA 20 according to the present invention includes the following:

The AP 10 maintains a list of all AMID values that are currently assigned.

The AP 10 also maintains a time value the “Inactivity Time” for each AMID value and if no message is received from a STA 20 using a particular AMID value within the Inactivity Time, then that AMID value becomes invalid and is discarded by the AP 10.

The AP 10 inserts into the list of AMID values a new value when it is agreed between the AP 10 and a STA 20 according to the present invention.

The AMID value is only used on messages exchanged between the AP 10 and STAs, such as 20. Messages forwarded by the AP 10 to other network devices shall not use the AMID values. The AP 10 shall substitute a globally valid MAC address for the AMID in such messages.

The procedure for selecting and agreeing an AMID value shall be as follows:
The STA 20 shall observe and note AMID values used by other STAs in the target network.
The STA 20 shall randomly select a new AMID value. If the selected value matches any currently in use for the network, it shall be discarded and a new random value selected.
The STA 20 shall generate a random value called a “Commit Key” and shall store this value.
The STA 20 shall compute a value called “Commit Value” by hashing together the selected AMID and Commit key using a cryptographic algorithm known publicly such as SHA-256 (Secure Hash Signature Standard (SHS) FIPS PUB 180-2.).
The STA 20 shall send a message to the AP indicating an intent to use a new AMID value and containing the Commit Value and using the AMID as its identifying MAC address (Source MAC Address).
The AP 10 shall confirm that the proposed AMID value is not currently in use. If it is in use, the AP 10 may indicate this to the STA 20 and take no further action. If it is not in use, the AP 10 shall store the new AMID in the table and reply to the STA 20 indicating the value of Inactivity Time for the AMID.
Upon receiving the reply, the STA 20 may proceed to establish a connection to the AP 10 using the AMID as its MAC identifier. When a suitable confidentiality protocol has been established, the STA 20 may send a global MAC address to the AP 10 for use in other networks.
When the STA 20 no longer wishes to use the AMID value, it shall send a message to inform the AP 10 and shall include in the message the value of “Commit key”. The AP 10 shall compute the hash value of Commit key and AMID and confirm a match with the previously stored Commit value and, if matching, shall remove the AMID from its AMID table. Note: the use of the Commit value prevents another STA from “stealing” the AMID by forging a disconnect message.
If the STA 20 does not send any messages using the AMID for the Inactivity Time, then it shall discard the AMID and presume that its connection to the AP 10 is lost.

Prior to making a connection to a new AP, the STA 20 may communicate with the new AP via some other network. For example it may communicate via another AP and send messages via some backbone network connecting APs. Since the AMID may not be used in other networks, the STA 20 must use its globally assigned MAC Address to identify itself in such cases. However, the STA 20 may acquire an AMID from the target AP and then communicate the value of the AMID to the new AP via the alternative network path by including the AMID value within the body of messages. This will allow the new AP to identify the STA 20 using it AMID value when it makes a wireless connection.

### Implementation of the Functionality of the Modules

The functionality of the AP 10 and STA 20 described above may be implemented in the corresponding AP/STA agreed-upon address modules 12 and 22 shown in FIGS. 3 and 4. By way of example, and consistent with that described herein, the functionality of the AP/STA agreed-upon address modules 12 and 22 may be implemented using hardware, software, firmware, or a combination thereof, although the scope of the invention is not intended to be limited to any particular embodiment thereof. In a typical software implementation, the module 12 and 22 would be one or more microprocessor-based architectures having a microprocessor, a random access memory (RAM), a read only memory (ROM), input/output devices and control, data and address buses connecting the same. A person skilled in the art would be able to program such a microprocessor-based implementation to perform the functionality described herein without undue experimentation. The scope of the invention is not intended to be limited to any particular implementation using technology now known or later developed in the future. Moreover, the scope of the invention is intended to include the modules 12 and 22 being a stand alone modules, as shown, or in the combination with other circuitry for implementing another module.

The other modules 14 and 24 and the functionality thereof are known in the art, do not form part of the underlying invention per se, and are not described in detail herein. For example, the other modules 24 may include other modules that formal part of a typical mobile telephone or terminal, such as a UMTS subscriber identity module (USIM) and mobile equipment (ME) module, which are known in the art and not described herein.

### Advantages/Disadvantages

The present invention has the following advantages:

1) The AMID value may be assigned for a limited time and does not have an externally known algorithmic or visible connection to the STA or its MAC address.

2) The AMID value may be assigned to a given STA and only the “owning” STA can instruct the AP to discard the value. Therefore, other STAs cannot steal the value while it is in use.

3) The AMID value is discarded automatically if it is not used. Therefore, if an “owning” STA is unable to inform the AP that it does not want the value the system is self healing.

4) Because the system is self healing the STA can at any time select and use a new AMID if it forgets the old value or loses the Commit Key value. This avoids the current problem whereby STAs become unable to connect.

5) The value of the AMID chosen is not disclosed until the first message where it is also committed. This prevents and attacker from implementing a pre-emptive denial of service attack by reserving a legitimate station's MAC address for itself.

### Motivation

Some motivation for the aforementioned solution is as follows:

The IEEE 802.11 standard has been used in a wide range of mainstream business and personal applications. The success of products has resulted in an increased dependency on IEEE 802.11 as a primary method for the interconnection of networking equipment. This increased dependence has resulted in a need for assurance that the system will not be disrupted by the actions of unauthorized equipment. Such disruption can be caused by malicious systems generating false information and impersonating valid equipment.

The current IEEE 802.11 standard including amendment ‘i’ (security) addresses security of data frames but systems are still vulnerable to malicious attack because management frames are unprotected. At the same time, there is an increased dependence on management frames as a result of IEEE 802.11 amendments such as IEEE 802.11h. Based on the examples of amendments ‘e’ and ‘k’, this trend is likely to continue.

Therefore, by reducing the susceptibility of systems to such attack, the result of the work envisioned in the present invention will be applicable and of importance to all the current applications of IEEE 802.11 and both existing and anticipated amendments.

### Scope of the Invention

Accordingly, the invention comprises the features of construction, combination of elements, and arrangement of parts which will be exemplified in the construction hereinafter set forth.

It will thus be seen that the objects set forth above, and those made apparent from the preceding description, are efficiently attained and, since certain changes may be made in the above construction without departing from the scope of the invention, it is intended that all matter contained in the above description or shown in the accompanying drawing shall be interpreted as illustrative and not in a limiting sense.

What I claim is:

1. A method comprising:
coupling an access point (AP) or other suitable network node or terminal and a station (STA) or other suitable network node or terminal in a wireless LAN network;
the AP and the STA agreeing on an arbitrary Medium Access Address (MAC) or other suitable arbitrary address, associated with a secret value, where the arbitrary MAC is for use by the STA and the AP during a connection.

2. A method according to claim 1, wherein the arbitrary MAC address is an “Association MAC Identifier” (AMID) that is used by the STA and AP to form a mutual connection.

3. A method according to claim 2, wherein the arbitrary MAC address is an “Association MAC Identifier” (AMID) that is used in all subsequent communications for the connection.

4. A method according to claim 1, wherein the STA may discard an agreed-upon address and acquire a new address to establish a new connection at any time.

5. A method according to claim 1, wherein the STA may operate with multiple agreed-upon addresses at the same time.

6. A method according to claim 1, wherein, once an agreed-upon address is assigned to the STA, another STA is prevented from acquiring the same agreed-upon address value until either the original STA has relinquished the agreed-upon address or the validity of the agreed-upon address has expired.

7. A method according to claim 2, wherein the AP maintains a list of all AMID values that are currently assigned.

8. A method according to claim 2, wherein the AP maintains a time value the “Inactivity Time” for each AMID value and if no message is received from the STA using a particular AMID value within the inactivity time, then that AMID value becomes invalid and is discarded by the AP.

9. A method according to claim 7, wherein the AP inserts into the list of AMID values a new value when it is agreed between the AP and the STA.

10. A method according to claim 2, wherein the AMID value is only used on messages exchanged between the AP and STAs, while other messages forwarded by the AP to other network devices shall not use the AMID values.

11. A method according to claim 10, wherein the AP shall substitute a globally valid MAC address for the AMID in the other messages.

12. A method according to claim 2, wherein the method for selecting and agreeing an AMID value includes one or more steps alone or in combination, as follows:
the STA shall observe and note AMID values used by other STAs in the target network;
the STA shall randomly select a new AMID value, and if the selected value matches any currently in use for the network, it shall be discarded and a new random value selected;
the STA shall generate a random value called a “Commit Key” and shall store this value;
the STA shall compute a value called “Commit Value” by hashing together the selected AMID and Commit key using a cryptographic algorithm known publicly;
the STA shall send a message to the AP indicating intent to use a new AMID value and containing the Commit Value and using the AMID as it's identifying MAC address (Source MAC Address);
the AP shall confirm that the proposed AMID value is not currently in use, and if it is in use the AP may indicate the same to the STA and take no further action, and if the proposed AMID value is not in use, the AP shall store the proposed AMID in the table and reply to the STA indicating the value of inactivity time for the AMID;
upon receiving the reply, the STA may proceed to establish a connection to the AP using the proposed AMID as its MAC identifier, including when a suitable confidentiality protocol has been established, the STA may also send a global MAC address to the AP for use in other networks;
when the station no longer wishes to use the AMID value, it shall send a message to inform the AP and shall include in the message the value of “Commit key”, and the AP shall compute the hash value of Commit key and AMID and confirm a match with the previously stored Commit value and if matching shall remove the AMID from its AMID table; and/or
if the STA does not send any messages using the AMID for the inactivity time, then it shall discard the AMID and assume that its connection to the AP is lost.

13. A method according to claim 1, wherein, prior to making the connection to a new AP, the STA may communicate with the new AP via some other network, including a backbone network connecting APs.

14. A wireless LAN network comprising:
an access point (AP) or other suitable network node or terminal for coupling to a station (STA) or other suitable network node or terminal;
the AP and the STA agreeing on an arbitrary Medium Access Address (MAC) or other suitable arbitrary address, associated with a secret value, where the arbitrary MAC is for use by the STA and the AP during a connection.

15. A wireless LAN network according to claim 14, wherein the arbitrary MAC address is an “Association MAC Identifier” (AMID) that is used by the STA and AP to form a mutual connection.

16. A wireless LAN network according to claim 14, wherein, prior to making the connection to a new AP, the STA may communicate with the new AP via some other network, including a backbone network connecting APs.

17. An access point (AP) or other suitable network node or terminal comprising:
one or more modules configured for coupling to a station (STA) or other suitable network node or terminal in a wireless LAN network;
the AP and the STA agreeing on an arbitrary Medium Access Address (MAC) or other suitable arbitrary address, associated with a secret value, where the arbitrary MAC is for use by the AP during the connection.

18. An access point (AP) or other suitable network node or terminal according to claim 17, wherein the arbitrary MAC address is an “Association MAC Identifier” (AMID) that is used by the STA to form the connection with the AP.

19. An access point (AP) or other suitable network node or terminal according to claim 18, wherein the arbitrary MAC address is an “Association MAC Identifier” (AMID) that is used in all subsequent communications for the connection.

20. An access point (AP) or other suitable network node or terminal according to claim 17, wherein the STA may discard an agreed-upon address and acquire a new address to establish a new connection at any time.

21. An access point (AP) or other suitable network node or terminal according to claim 17, wherein the STA may operate with multiple agreed-upon addresses at the same time.

22. An access point (AP) or other suitable network node or terminal according to claim 17, wherein, once an agreed-upon address is assigned to the STA, another STA is prevented from acquiring the same agreed-upon address value until either the original STA has relinquished the agreed-upon address or the validity of the agreed-upon address has expired.

23. An access point (AP) or other suitable network node or terminal according to claim 17, wherein, prior to making the connection to a new AP, the STA may communicate with the new AP via some other network, including a backbone network connecting APs.

24. A station (STA) or other suitable network node or terminal comprising:
one or more modules configured for coupling to an access point (AP) or other suitable network node in a wireless LAN network;
the AP and the STA agreeing on an arbitrary Medium Access Address (MAC) or other suitable arbitrary address, associated with a secret value, where the arbitrary MAC is for use by the STA during a connection.

25. A station (STA) or other suitable network node or terminal according to claim 24, wherein the arbitrary MAC address is an “Association MAC Identifier” (AMID) that is used by the STA to form the connection with the AP.

26. A station (STA) or other suitable network node or terminal according to claim 25, wherein the arbitrary MAC address is an “Association MAC Identifier” (AMID) that is used in all subsequent communications for the connection.

27. A station (STA) or other suitable network node or terminal according to claim 24, wherein the STA may discard an agreed-upon address and acquire a new address to establish a new connection at any time.

28. A station (STA) or other suitable network node or terminal according to claim 24, wherein the STA may operate with multiple agreed-upon addresses at the same time.

29. A station (STA) or other suitable network node or terminal according to claim 24, wherein, once an agreed-upon address is assigned to the STA, another STA is prevented from acquiring the same agreed-upon address value until either the original STA has relinquished the agreed-upon address or the validity of the agreed-upon address has expired.

30. A station (STA) or other suitable network node or terminal according to claim 24, wherein, prior to making the connection to a new AP, the STA may communicate with the new AP via some other network, including a backbone network connecting APs.

31. A computer program product with a program code, which program code is stored on a machine readable carrier, for carrying out a method comprising: the AP and the STA agreeing on an arbitrary Medium Access Address (MAC) or other suitable arbitrary address, associated with a secret value, where the arbitrary MAC is for use by the STA and the AP during a connection, when the computer program is run in a module of either the AP, the STA, or some combination thereof.

32. A method according to claim 1, wherein the method further comprises implementing the step of the method via a computer program running in a processor, controller or other suitable module in one or more network nodes, terminals or elements in the wireless LAN network.

33. Apparatus comprising:
means for coupling an access point (AP) or other suitable network node or terminal and a station (STA) or other suitable network node or terminal in a wireless LAN network; and
means for forming an agreement between the AP and the STA on an arbitrary Medium Access Address (MAC) or other suitable arbitrary address, associated with a secret value, where the arbitrary MAC is for use by the STA and the AP during a connection.

34. Apparatus according to claim 33, wherein the arbitrary MAC address is an “Association MAC Identifier” (AMID) that is used by the STA and AP to form a mutual connection.
